(19) United States
(12) Patent Application Publication
(10) Pub. No.: US 2005/0211747 A1
(43) Pub. Date: Sep. 29, 2005

(54) Metal transfer in arc welding

(76) Inventors: Pei-Chung Wang, Troy, MI (US); Hai-Lung Tsai, Rolla, MO (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/806,675

(22) Filed: Mar. 23, 2004

(51) Int. Cl. B23K 1/00

(52) U.S. Cl. 228/101

(57) ABSTRACT

A double pulse welding current method is disclosed for the generation and transfer of droplets of welding metal from an electrode wire to a workpiece in an arc welding process. A suitable background direct current level is specified to deliver a desired number of droplets to the weld site. During each cycle of droplet formation and transfer, a first increased current pulse is applied to the electrode and arc to generate a droplet on the tip of and electrode and then a second further increased current pulse is applied to timely separate the droplet from the electrode for transport in the arc to the workpiece. This double-pulse current application reliably produces one droplet per cycle of pulses to deliver a specified number of droplets to the weld site for improved weld quality and reduced spatter or waste of weld metal.

### TECHNICAL FIELD

This invention pertains to the formation and transfer of molten metal droplets in arc welding. More specifically this invention pertains to the use and control of a pulsed welding current to generate and transfer one metal drop per double-pulse from a consumable welding electrode to a workpiece.

### BACKGROUND OF THE INVENTION

Gas metal arc welding (GMAW) is an arc welding process in which heat for welding is generated by an arc between a consumable electrode and the workpiece metal. The electrode is a metal wire that is continuously fed to the weld site and becomes the filler metal as it is consumed in the arc. The electrode, arc, weld puddle and adjacent area of the grounded workpiece are protected from atmospheric contamination by a gaseous shield. The gas shield is provided by a gas, or mixture of gasses, usually fed through an electrode wire holder. GMAW is used to join metal structures where a filler material is required to make the weld. It is often, but not always, performed with the workpiece(s) to be joined in a generally horizontal position for more precise placement of the falling spray or drops of liquid metal produced in the arc between the electrode wire and workpiece. In the manufacture of automotive vehicles, for example, this welding practice has much flexibility. It can be used to join workpieces of ferrous alloys, e.g., low carbon steels and other alloyed steels, or aluminum alloys or other metals.

GMAW requires an electrical power supply with sufficient voltage to produce a current across the electrode-workpiece gap and sufficient current to melt the electrode to make the weld metal deposit. The process requires a wire feeder that continuously advances the electrode wire as it melts and a smooth flow of shielding gas. An electrode holder, sometimes called a “gun”, is often used to simultaneously carry and direct the end of the electrode wire toward the weld site, contact the wire with electrical current, and direct the shielding gas at the weld site.

Direct current power sources are usually used for GMAW, and they are variously controlled to deliver constant-current, or constant-voltage, or other welding current patterns during the welding of a workpiece. Computers operating with electric power controllers are often used, particularly in operations involving the formation of like or similar welds on a continual succession of workpieces.

GMAW also offers flexibility in the mode of metal transfer from the tip of the consumable electrode wire to the molten weld puddle at the weld site. In a spray-arc mode, the metal is transferred from the wire to the puddle in an axial stream of fine droplets. In a globular mode of metal transfer, the current density is controlled so that a relatively large drop of molten metal forms at the end of the electrode wire, and the drop hangs on the tip for a small fraction of a second until the force of gravity exceeds the surface tension retaining the drop and it falls into the molten weld deposit. In a short-circuiting mode of metal transfer, the weld current is controlled so that the molten droplet formed on the weld tip grows and touches the weld puddle before it falls into the puddle. While the droplet touches the puddle a momentary short circuit exists which is broken when the drop falls. This short circuit-broken circuit phenomenon may be repeated several times in the formation of each weld. It is found that the control of such GMAW welding modes is dependent on the delivery of molten filler metal from the consumable electrode to the workpiece(s). The welder or welding control system needs to manage the deposit of molten weld material so that the solidified joint is strong and complete and free of spatter and waste.

It is an object of this invention to provide a method of delivering or transferring a known and reproducible quantity of metal from the electrode wire to the weld site during gas metal arc welding. It is a more specific object of this invention to provide a method of controlling current pulses to the electrode to achieve about one droplet of molten metal per double-pulse current cycle in such welding.

### SUMMARY OF THE INVENTION

Metal transfer in gas metal arc welding refers to the process of transferring material of the welding wire in the form of molten liquid droplets to the workpiece. Such metal transfer plays an important role in the stability of the welding process and the quality of resulting welds. Experimental observations show that welding current is a very important factor affecting the mode of metal transfer and, subsequently, weld quality. In accordance with this invention, an electrical power system and wave form generator control is employed to provide a direct current arc between the electrode tip and weld puddle during the formation of a gas metal arc weld. The wave form of the current during each drop of metal transfer is characterized by a background current to sustain a suitable arc, a first current pulse to enhance drop formation at the tip of the electrode and a shorter but greater second current pulse to affect separation of the drop from the electrode.

In setting up a welding operation for workpiece(s) of known thickness to be welded, the metal composition of the workpiece is known and the composition of the welding electrode and shielding gas specified. Based on experience, prior testing and/or mathematical modeling, operating parameters for the welding job are established. These welding operating parameters include, for example, electrode diameter, length of electrode protrusion from the electrode holder or gun, shielding gas flow rate, internal diameter of shielding nozzle, wire feed speed, and the like. Such parameters are coordinated with the welding current and voltage and, in accordance with this invention, the welding current is pulsed twice and controlled to deliver one drop of weld metal from the electrode tip each pulsing cycle. Such controlled metal transfer contributes to the formation of a succession of welds of good quality with minimized spatter and waste.

A double pulse cycle is specified to produce a droplet of weld metal. For example, a cycle of one droplet each ten milliseconds (ms) may be employed during the formation of a particular weld which may take a few seconds for completion. During each ten millisecond cycle of the welding operation, a continuous background current is employed of, e.g., one hundred amperes to create and sustain the arc between the electrode tip and workpiece. A first current pulse is generated and imposed on top of the background current to promote generation of a droplet on the end of the electrode. This current pulse is sustained for a fraction of the ten-millisecond cycle period (for example, 3-4 ms) and is larger (for example, a total of three hundred amperes) than the background current. Then, when the droplet has been suitably formed, a second current pulse larger (for example, a total of eight hundred amperes) than the first pulse is imposed on top of the first pulse to promote separation of the droplet from the electrode wire tip. The duration of the second current pulse is also a fraction (for example, 0.5 ms) of the drop forming cycle. This cycle of background current, first current impulse for droplet formation and second current impulse for droplet separation is repeated until sufficient metal transfer has occurred to complete a weld task. Current flow is stopped and the welded workpiece removed from the welding area. A new workpiece may then be placed for welding.

The one drop of molten weld metal per two-pulse current cycle of this invention permits controlled and repeatable formation of high quality welds with minimal waste of electrode material. Once a suitable background welding current and increased current pulse levels and durations have been established for a workpiece the control of the welding press is easily managed and modified if necessary. Many like welds can be readily produced in the joining of like workpiece assemblies. The process will be illustrated in GMAW but is applicable in arc welding processes in general.

Other objects and advantages of the invention will become apparent from a detailed description of preferred embodiments of the invention which follow.

### BRIEF DESCRIPTION OF THE DRAWINGS

FIG. 1 is a schematic view of an assembly of a workpiece and welding apparatus for the practice of this invention.

FIG. 2 is a graph of welding current versus time in milliseconds during the formation of three drop formation and separation cycles in an embodiment of this invention.

FIGS. 3A-3C are schematic views of the formation of the bare arc, FIG. 3A; the formation of a droplet of weld metal on the tip of a welding wire electrode, FIG. 3B; and the separation of the droplet from the electrode, FIG. 3C, all in one droplet forming, two-phase current cycle in an embodiment of this invention.

### DESCRIPTION OF THE PREFERRED EMBODIMENT

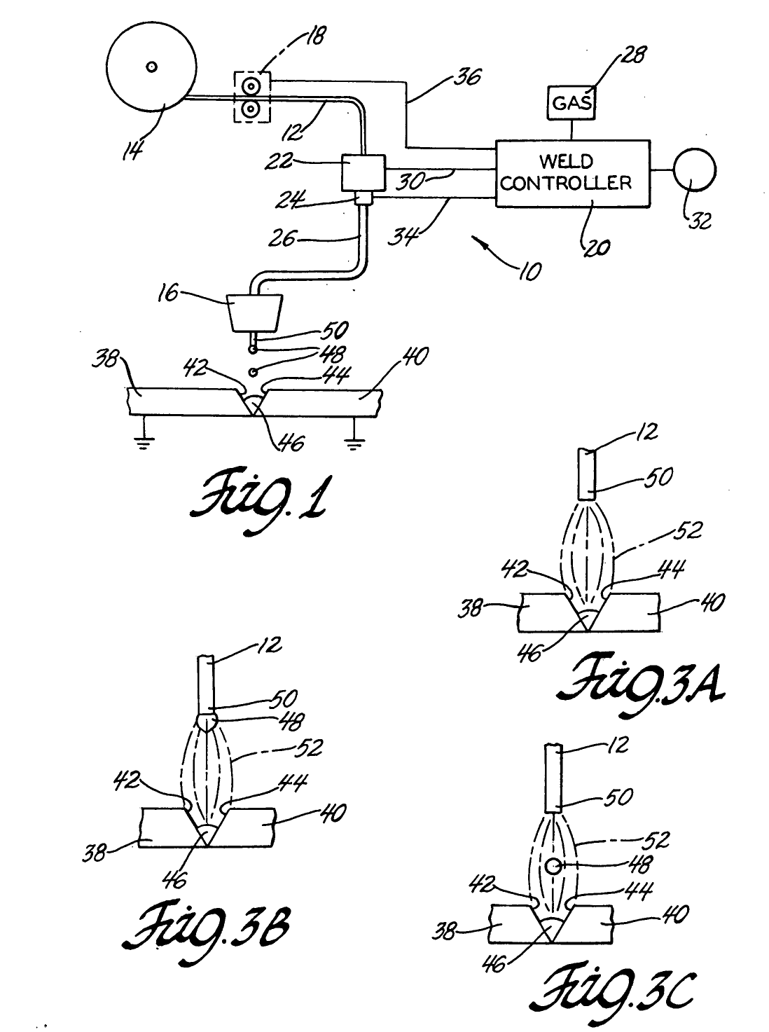

FIG. 1 is a schematic illustration, not to size scale, of representative apparatus 10 for a practice of GMAW. Consumable electrode wire 12 is unwound from roll 14 and delivered to an electrode holder 16 through a stand 18 of feed rolls. A weld process controller 20 controls the speed of advancement of electrode wire 12 through roll stand 18 as well as the delivery of shielding gas and electrical current to the weld site. Electrode wire 12 advances through gas plenum 22 and electric current connector 24 and is fed through a flexible conduit 26 which contains the current-carrying electrode wire and shielding gas to electrode holder 16.

Argon or other selected shielding gas is delivered from a pressurized tank 28 or other source through gas delivery line 30 as managed by controller 20. Similarly a source of suitable electric power 32 is provided and delivered through electrical lead 34 to the electrical connector 24 for electrode wire 12. As will be described in more detail, welding controller 20 has the capability of controlling and varying the amount of current delivered at millisecond timing from source 32 to connector 24 and electrode wire 12. Controller 20 also controls the movement of feed rolls on stand 18 through control line 36.

Electrode holder 16 is illustrated positioned above plates 38, 40 which have their abutting sides 42, 44 suitably tapered to receive weld metal 46. If, for example, plates 38 and 40 are made of a stainless steel composition, the electrode wire 12 may also be of a suitable stainless steel composition. Weld metal 46 is shown as an un-solidified puddle receiving droplets 48 of weld metal transferred from the tip portion 50 of electrode wire protruding downwardly from electrode holder 16. Often electrode holder has a central passage, not shown, for electrode 12 and a separate, parallel flow passage, not shown, for the flow of shielding gas.

GMAW may be conducted by moving electrode holder over or around an assembly of workpieces to produce a number of welds in the fabrication of an article of manufacture. In this embodiment, the electrode holder may be carried by a robot arm or other programmable or controllable carrier. In other GMAW applications a succession of workpieces are brought to a welding center and successively placed under a welding gun such as that indicated schematically at 16. The practice of this invention may be used in any such GMAW or other arc welding application in which it is desired to control the formation and separation of drops of melding metal from an electrode.

GMAW often uses direct current to form the arc 52 between electrode tip 50 and workpieces 38 and 40. Thus electric power source 32 delivers rectified alternating current or direct current to electrical connector 24 under the management of welding controller 20. Welding controller 20 includes current control circuitry to provide a constant background current level and pulses of increased current levels.

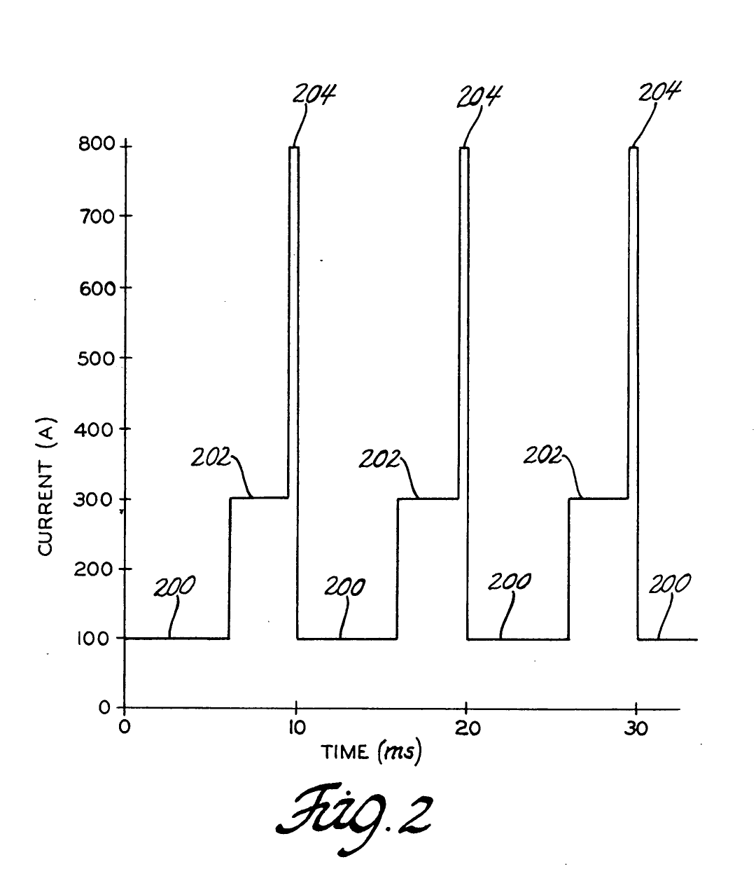

FIG. 2 is a graph of current in amperes (A) versus time in milliseconds (ms). The current is delivered to connector 24 and electrode wire 12 in forming an individual weld. In the welding example illustrated in FIG. 2, a constant background current of about 100 amperes is delivered to electrode tip 50 to form a discharge of electrical current, an arc, between tip 50 and abutting ends 42, 44 of workpieces 38, 40. The abscissa of FIG. 2 is a timeline spanning about 33 milliseconds (ms). The 100 A background current is indicated by horizontal line 200 in FIG. 2 and is continued throughout weld formation.

In the illustration in FIG. 2, a droplet forming and transferring cycle of 10 ms is employed and three such cycles are illustrated in the figure. Starting at the beginning of an illustrative cycle (t=0 in FIG. 2) the background current 200 is passed between the electrode 12 and workpieces 38, 40 to maintain arc 52. After about 6 ms, a current pulse of a total of 300 A is applied for about 3.5 ms. This is a current level of 200 A above the background current level. The 300 ampere pulse level in each droplet forming cycle and its 3.5 ms duration are indicated for the successive cycles by horizontal line segments 202. After a droplet forming current pulse level of 300 A for 3.5 ms, a second current impulse totaling 800 A is imposed on electrode tip 50 for about 0.5 ms. The 800 A pulse level in each droplet forming and transferring cycle and its 0.5 ms durations are indicated by horizontal line segments 204 in FIG. 2. Following the termination of the 800 A pulse, the next 10 ms (in this example) droplet formation and separation cycle begins. Again, only the background current of 100 A is passed through the electrode tip 50 and arc for the next 6 ms until the first current pulse 202 is again imposed to enhance the formation of the next droplet for the weld formation between workpieces 38, 40.

FIGS. 3A-3C are schematic illustrations of droplet 48 formation at the tip 50 of electrode wire 12 and transfer of the metal droplet 48 to weld puddle 46. FIG. 3A depicts the existence of arc 52 between electrode tip 50 and workpieces 38 and 40 and weld metal puddle 46 under the steady background current of 100 A (current level 200 in FIG. 2). Upon the application of the first current pulse totaling 300 A, droplet formation occurs as illustrated by droplet 48 in FIG. 3B. The duration of the first impulse current is brief, about 3.5 ms, as shown in FIG. 2. The second impulse current totaling 800 A provides sufficient electromagnetic field and force around the droplet 48 of FIG. 3B to pinch it from electrode tip 50 and permit it to drop, FIG. 3C, from tip 50 in arc 52 into weld puddle 46. The droplet forming and transferring steps illustrated in FIG. 2 and FIGS. 3A-3C are repeated at 10 millisecond cycle intervals until a predetermined sufficient quantity of weld metal has been thus transferred from weld electrode 12 to the weld metal puddle 46. The weld metal soon solidifies by heat loss to the abutting pieces 38 and 40 to form a strong weld free of excess metal and spatter.

A least two ways can be used to produce direct current for use in pulsed arc welding. In one practice, standard single phase or three phase 60 Hz alternating current is supplied to the welding operation and converted to unidirectional current using a conventional rectifier. In a second practice, the available alternating current is again converted to unidirectional current using a rectifier. The direct current is applied to an inverter section of the power supply where solid-state controls switch it on and off at frequencies as high as 20,000 Hz, effectively converting it back to high frequency AC. The pulsed, high voltage, high frequency AC then is fed to a transformer where it is transformed into relatively low voltage, high current AC. Finally, this current is directed through a filtering and rectifying circuit to obtain the desired unidirectional welding current. The current level is controlled at millisecond intervals to produce the predetermined background current level and the first and second pulse levels in accordance with the welding process of this invention.

The procedure to devise the background current and current impulses is as follows. For a given wire diameter (e.g. D_{w}=1.2 mm=2r_{w} where r_{w} is the radius of the electrode wire), the background current (e.g., I_{b}=100 A) to sustain the arc between the workpiece and electrode can be determined based on reference welding current data found in the American Welding Society Handbook. Then, the first current pulse, which should be higher than the transition current (240 A) given in AWS Handbook, is chosen (e.g., Iₚ=300 A). Then, the duration (tₚ) of first current pulse can be estimated based on the energy balance during droplet formation process using

$$π {r}_{w}^{2} [ ( 1 / f - {t}_{p} ) {V}_{b} + {t}_{p} {V}_{p} ] = \frac{4}{3} π {r}_{d}^{3} ,$$

where V_{b} (velocity of electrode wire during background current)=4 cm/second and Vₚ (velocity of electrode wire during peak current)=17.8 cm/second, r_{d} is the radius of the molten droplet (i.e., 0.6 mm), f is the frequency). With the given pulse frequency and droplet size, the wire feed speed, V, is determined based on the mass balance equation (i.e.,

$$V = \frac{4}{3} \frac{{r}_{d}^{3}}{{r}_{w}^{2}} f = 8$$

cm/sec, where r_{d} is the radius of the molten droplet and r_{w} is the radius of the electrode wire). Finally, a second pulse current (e.g., 800 A) is selected and superimposed for a short duration (e.g., 0.2 ms) to precisely generate and cut off a droplet. The current magnitude should be high enough to chop off the molten droplet in a short duration.

The practice of the invention utilizes two current pulses imposed on a background current to time the formation and transfer of each droplet of weld metal contributing to an individual weld. The goal is to transfer one drop of weld metal per two-current pulse cycle. In the above example, each cycle totaled about ten milliseconds. The droplet forming current impulse is usually for less than half of the total cycle and the droplet releasing impulse is usually much shorter than the droplet forming impulse. The specific durations of the total cycle and current impulses are based on an analysis of the weld electrode material and size and the background current and current pulse combination found to be useful to deliver a suitable droplet in a several millisecond time interval. Like GMAW, the practice of this invention can be applied to welding many different metal compositions using electrode materials of appropriate composition.

Accordingly, while the invention has been illustrated by a preferred embodiment it is apparent that other embodiments could readily be adapted by one skilled in the art. The scope of the invention is limited only by the scope of the following claims.

1. A method of forming a droplet of weld metal on a welding wire electrode and separating the droplet from the electrode in an arc welding process, said method comprising:
establishing a direct current flow in an arc between said electrode and a workpiece at a background current flow level over a welding cycle time period for forming a droplet on said electrode and transferring said droplet in said arc to said workpiece;
producing a first pulse in said current flow, during said welding cycle time period, at a first pulsed current flow level greater than said background current flow level for forming said droplet on said electrode; and
producing a second pulse in said current flow, during said welding cycle time period, at a second pulsed current flow level greater than said first pulsed current flow level for separating said droplet from said electrode and for transfer in said arc to said workpiece.

2. A method as recited in claim 1 in which said current is continued at said background flow level and said first and second current flow pulses are repeated to form and transfer a corresponding plurality of droplets of weld material from said electrode to said workpiece to form a weld in said workpiece.

3. A method as recited in claim 1 in which the duration of said first pulse in said current flow is a first pulse period that is less than half of said welding cycle time period.

4. A method as recited in claim 3 in which the duration of said second pulse in said current flow is a second pulse period that is less than said first pulse period.

5. A method as recited in claim 1 which is conducted in a gas metal arc welding process and in which said droplet is transferred in a globular mode.

6. A method as recited in claim 2 which is conducted in a gas metal arc welding process and in which said droplet is transferred in a globular mode.

7. A method as recited in claim 3 which is conducted in a gas metal arc welding process and in which said droplet is transferred in a globular mode.

8. A method as recited in claim 4 which is conducted in a gas metal arc welding process and in which said droplet is transferred in a globular mode.

9. A method of forming a droplet of weld metal on a welding wire electrode and separating the droplet from the electrode in a gas metal arc welding process, said method comprising:
establishing a direct current flow in an arc between said electrode and a workpiece at a background current flow level over a welding cycle time period for forming a droplet on said electrode and transferring said droplet in said arc to said workpiece;
producing a first pulse in said current flow, during said welding cycle time period, at a first pulsed current flow level greater than said background current flow level for forming said droplet on said electrode; and
producing a second pulse in said current flow, during said welding cycle time period, at a second pulsed current flow level greater than said first pulsed current flow level for separating said droplet from said electrode and for transfer in said arc in a globular mode to said workpiece.

10. A method as recited in claim 9 in which said current is continued at said background flow level and said first and second current flow pulses are repeated to form and transfer a corresponding plurality of droplets of weld material from said electrode to said workpiece to form a weld in said workpiece.

11. A method as recited in claim 9 in which the duration of said first pulse in said current flow is a first pulse period that is less than half of said welding cycle time period.

12. A method as recited in claim 11 in which the duration of said second pulse in said current flow is a second pulse period that is less than said first pulse period.
